(19) United States
(12) Patent Application Publication
(10) Pub. No.: US 2025/0326564 A1
(43) Pub. Date: Oct. 23, 2025

(54) ACTUATOR NOZZLE FOR AEROSOL PACKAGING, AND METHODS OF MAKING AND USING SUCH ACTUATOR NOZZLES AND AEROSOL PACKAGINGS

(71) Applicant: SOCIETE DES PRODUITS NESTLE S.A., VEVEY (CH)

(72) Inventors: Nathan Opet, Grove City, OH (US); Lija Preston, Pickerington, OH (US); Jun-Tse Ray Fu, Dublin, OH (US); Vicki Catalina, Chelsea, MI (US); Christopher Wolak, Wind lake, WI (US); Lawrence Mozdrzech, Dublin, OH (US)

(21) Appl. No.: 19/182,768

(22) Filed: Apr. 18, 2025

Related U.S. Application Data
(60) Provisional application No. 63/636,308, filed on Apr. 19, 2024.

(51) Int. Cl. B65D 83/28; B65D 83/16

(52) U.S. Cl. CPC B65D 83/28; B65D 83/16

(57) ABSTRACT

An actuator nozzle has a lower portion comprising a base configured to connect to a container, and the base includes a lower orifice. The actuator nozzle also has an upper portion including a tapered section on one side of the upper portion, the tapered section tapers inward as the tapered section extends upward from the lower portion, the upper portion further having a substantially vertical section on an opposite side of the upper portion from the tapered section. The actuator nozzle also has an upper orifice in fluid communication with the lower orifice by an interior channel of the actuator nozzle, the upper orifice angled downward from a top of the tapered section of the upper portion to a top of the substantially vertical section of the upper portion.

### CROSS REFERENCE TO RELATED APPLICATIONS

The present application claims priority to U.S. Provisional Patent Application No. 63/636,308 filed Apr. 19, 2024, the entire contents of which are incorporated herein by reference.

### BACKGROUND

The present disclosure generally relates to an actuator nozzle for aerosol packaging comprising a container, for example a pressurized aerosol can, which may contain a fluid product such as a foaming liquid creamer.

Milk or milk substitutes may be stored in and dispensed from pressurized cans. However, such pressurized cans may not reproducibly achieve a satisfactory foam effect when dispensing the milk or milk substitute.

### BRIEF DESCRIPTION OF THE FIGURES

FIG. 1 shows a perspective view of a non-limiting embodiment of an actuator nozzle according to the present disclosure.

FIG. 2 shows a top view of the non-limiting embodiment of FIG. 1.

FIG. 3 shows a back view of the non-limiting embodiment of FIG. 1.

FIG. 4 shows a side view of the non-limiting embodiment of FIG. 1.

FIG. 5 shows a front view of the non-limiting embodiment of FIG. 1.

FIG. 6 shows a side cross-section view of the non-limiting embodiment of FIG. 1.

FIG. 7 shows a bottom view of the non-limiting embodiment of FIG. 1.

FIG. 8 shows experimental results from comparative tests between a star-tip nozzle, a common commercial component, and the inventive actuator nozzle according to the present disclosure.

### DETAILED DESCRIPTION

The present disclosure relates to an actuator nozzle, preferably partially or entirely made of plastic, for aerosol packaging comprising a container, for example a pressurized aerosol can which may contain a fluid product such as a foaming liquid creamer. The actuator nozzle may dispense the fluid product from the aerosol packaging to create a foam creamer. The actuator nozzle comprises an internal channel that extends between (i) a lower orifice configured for the fluid product to enter the actuator nozzle from the container and (ii) an upper orifice configured to dispense the fluid product from the actuator nozzle.

Preferred embodiments of the actuator nozzle have a substantially vertical central axis around which a lower portion of the actuator nozzle is substantially symmetrical, and the actuator nozzle tapers inward on one side of an upper portion of the actuator nozzle. The actuator nozzle may be partnered with a valve to allow a consumer to dispense a foaming liquid creamer from the container (e.g., a pressurized aerosol can).

Preferred embodiments of the actuator nozzle have a tapered upper orifice that is angled downward from horizontal, and the upper orifice may have an oval or semi-circle shape, to thereby provide a jet stream that whitens a cup containing a beverage such as coffee or tea, while the outer edges of the orifice with the larger gap therebetween deflect the dispensed milk substitute product that creates foam on top of the beverage. The wider part of the tapered orifice may be adjacent the top end of the nozzle and may provide smaller bubbles in the dispensed milk substitute product, allowing for a thicker, denser appearing foam. These features of the actuator nozzle may allow consumers to have a whitened cup and a foam creamer, without the need to mix the dispensed fluid product into the beverage, thereby eliminating tools or utensils required for mixed coffee drinks. The tapered orifice also may be ergonomically superior to known actuator nozzles and may allow consumers to have a repeatable mess-free dispensing experience.

Additional features and advantages are described in, and will be apparent from, the following Detailed Description and the Figures. The features and advantages described herein are not all-inclusive and, in particular, many additional features and advantages will be apparent to one of ordinary skill in the art in view of the figures and description. Also, any particular embodiment does not have to have all of the advantages listed herein, and it is expressly contemplated to claim individual advantageous embodiments separately. Moreover, any embodiment may be combined with any other embodiment unless explicitly stated otherwise.

As used herein, “about,” “approximately” and “substantially” are understood to refer to numbers in a range of numerals, for example the range of −10% to +10% of the referenced number, preferably −5% to +5% of the referenced number, more preferably −1% to +1% of the referenced number, most preferably −0.1% to +0.1% of the referenced number or property. For example, a surface that is “substantially planar” is at least 90% planar, preferably 95% planar, more preferably 99% planar, most preferably 99.9% planar.

All numerical ranges herein should be understood to include all integers, whole or fractions, within the range. Moreover, these numerical ranges should be construed as providing support for a claim directed to any number or subset of numbers in that range. For example, a disclosure of from 1 to 10 should be construed as supporting a range of from 1 to 8, from 3 to 7, from 1 to 9, from 3.6 to 4.6, from 3.5 to 9.9, and so forth.

As used in this disclosure and the appended claims, the singular forms “a,” “an” and “the” include plural referents unless the context clearly dictates otherwise. Thus, for example, reference to “a product” or “the product” includes two or more products.

The words “comprise,” “comprises” and “comprising” are to be interpreted inclusively rather than exclusively. Likewise, the terms “include,” “including” and “or” should all be construed to be inclusive, unless such a construction is clearly prohibited from the context. Nevertheless, the compositions disclosed herein may lack any element that is not specifically disclosed herein. Thus, a disclosure of an embodiment using the term “comprising” includes a disclosure of embodiments “consisting essentially of” and “consisting of” the components identified.

The terms “at least one of” and “and/or” used respectively in the context of “at least one of X and Y” and “X and/or Y” should be interpreted as “X without Y,” or “Y without X,” or “both X and Y.” Where used herein, the terms “example” and “such as,” particularly when followed by a listing of terms, are merely exemplary and illustrative and should not be deemed to be exclusive or comprehensive.

As used herein, a “container” is any device that can hold, store and dispense an orally consumable fluid product. A “can” is a container which is substantially cylindrical and preferably partially or entirely made of metal.

As used herein, “downward” in the actuator nozzle refers to a direction toward the base of the actuator nozzle configured to connect to a container, and “upward” in the actuator nozzle refers to a direction toward the dispensing orifice of the actuator nozzle, wherein the base of the actuator nozzle configured to connect to a container is positioned at an opposite end of the actuator nozzle from the dispensing orifice of the actuator nozzle. Moreover, the “top” of the actuator nozzle refers to the portion of the actuator nozzle closest to the dispensing orifice, and the “bottom” of the actuator nozzle refers to the portion of the actuator nozzle closest to the base of the actuator nozzle. The central axis of the actuator nozzle is an axis around which the actuator nozzle is substantially symmetrical over a lower portion of the actuator nozzle. As used herein, “horizontal” means perpendicular to this central axis, and “vertical” means parallel to this central axis.

In preferred embodiments provided by the present disclosure, an actuator nozzle comprises: a lower portion comprising a base configured to connect to a container, the base comprising a lower orifice; an upper portion comprising a tapered section on one side of the upper portion, the tapered section tapers inward as the tapered section extends upward from the lower portion, the upper portion further comprising a substantially vertical section on an opposite side of the upper portion from the tapered section; and an upper orifice in fluid communication with the lower orifice by an interior channel of the actuator nozzle, the upper orifice angled downward from a top of the tapered section of the upper portion to a top of the substantially vertical section of the upper portion.

In some embodiments, the upper orifice has a shape that is oval or semi-circle and has a maximum width at or adjacent to the top of the tapered section.

Preferably the lower portion of the actuator nozzle is substantially symmetrical throughout an entirety of the height of the lower portion.

In some embodiments, the actuator nozzle comprises one or more pressure points configured to actuate and/or permit actuation of a valve on which the actuator nozzle is mounted. The one or more pressure points may be positioned on the tapered section of the upper portion. The one or more pressure points and the upper orifice may face opposite directions.

Preferably the actuator nozzle is partially or entirely made of plastic.

In some embodiments, the tapered section of the upper portion has a height greater than that of the substantially vertical section of the upper portion.

Another aspect of the present disclosure is an aerosol packaging comprising a pressurized container and further comprising any actuator nozzle disclosed herein. The pressurized container may be a pressurized aerosol can containing a foaming liquid creamer. In some embodiments, the aerosol packaging comprises a valve on which the actuator nozzle is mounted and configured to reversibly open and close the internal channel of the actuator, and preferably the valve is part of or attached to the pressurized container.

Yet another aspect of the present disclosure is a method of manufacturing an aerosol packaging, the method comprising attaching any actuator nozzle disclosed herein to a pressurized container. The method may comprise filling a foaming liquid creamer into the container before the attaching of the actuator nozzle to the container. The attaching the actuator nozzle to the pressurized container may comprise mounting the actuator nozzle on a valve that is part of or attached to the container.

Another aspect of the present disclosure is a method of dispensing a fluid product from a container, the fluid product preferably comprising a liquid foaming creamer, the method comprising directing the fluid product from the container through any actuator nozzle disclosed herein. Preferably the directing the fluid product through the actuator nozzle comprises forming a jet stream of the fluid product from the upper orifice and/or deflecting the fluid product between outer edges of the upper orifice to thereby create foam on top of beverage, such as coffee or tea, which the upper orifice is facing. In some embodiments, the directing of the fluid product through the actuator nozzle forms a foam creamer on a beverage, such as coffee or tea, without use of tools or utensils.

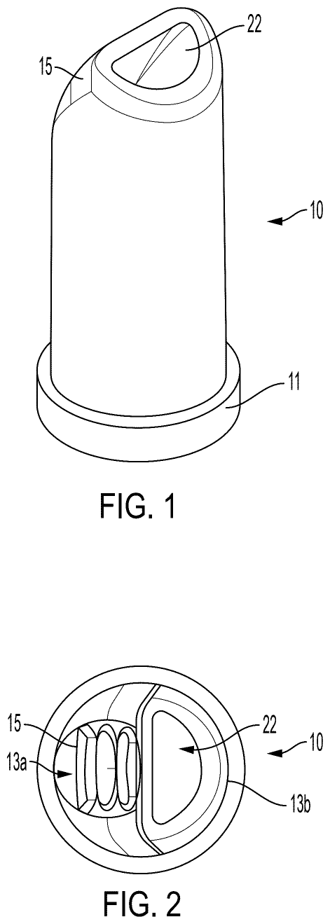

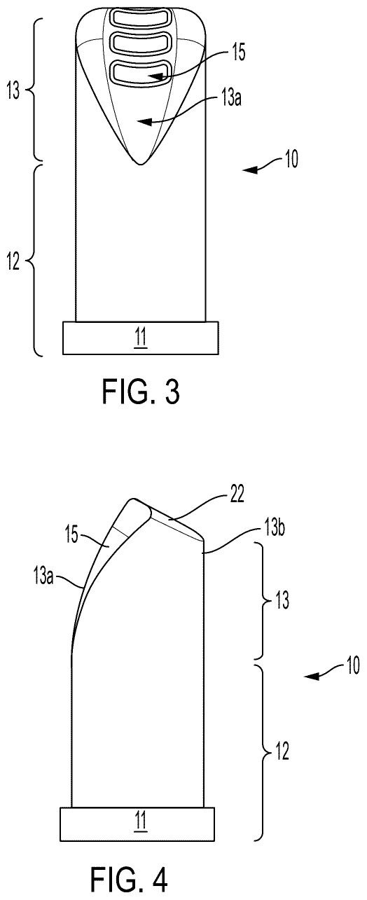

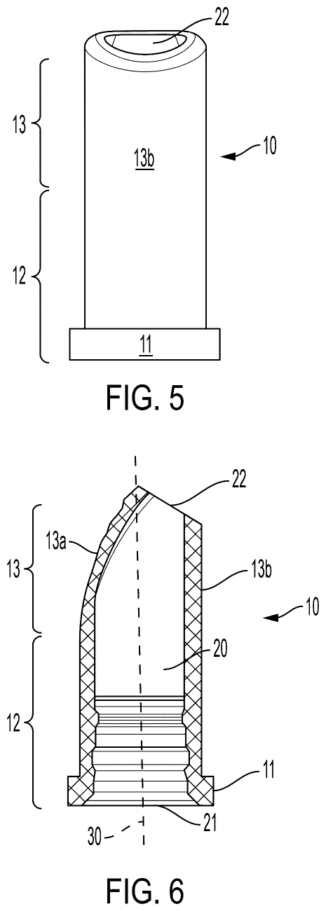

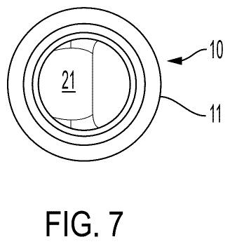

For general illustration, FIGS. 1-7 show an embodiment of an actuator nozzle 10. The actuator nozzle 10 may comprise a base 11 at a lower end of the actuator nozzle 10, and the base 11 may be configured to connect to a container. For example, the actuator nozzle 10 may comprise internal threads configured to attach to complementary threads provided by the container and/or provided by an attachment to the container.

In some embodiments, the container may be a pressurized aerosol can, which may contain an orally consumable fluid product such as a foaming liquid creamer. The aerosol packaging comprising the actuator nozzle 10 may include a valve, for example a valve on the container.

The actuator nozzle 10 comprises an internal channel 20 that extends between (i) a lower orifice 21 configured for a fluid product to enter the actuator nozzle 10 from the container (e.g., through the valve) and (ii) an upper orifice 22 configured to dispense the fluid product from the actuator nozzle 10. The upper orifice 22 preferably has an oval or semi-circle shape, with its widest portion at or adjacent the top of the upper orifice 22 and a continuously decreasing width as the upper orifice 22 extends downward.

The valve may reversibly close and open the internal channel 20, for example the lower orifice 21 at the bottom of the internal channel 20. The actuator nozzle 10 may comprise a lower portion 12 and an upper portion 13. The upper portion 13 may extend between the lower portion 12 and the upper orifice 22. The internal threads of the actuator nozzle 10 may extend into the internal channel 20 along at least part of the height of the lower portion 12 of the actuator nozzle.

The upper portion 13 of the actuator nozzle 10 may comprise one or more pressure points 15 configured to actuate the valve and/or permit actuation of the valve. Preferably the one or more pressure points 15 are positioned on a side of the upper portion 13 of the actuator nozzle 10 that tapers inward. The upper orifice 22 may be angled downward from the top of the tapered side of the upper portion 13 to the top of an opposite side of the upper portion 13, which may be a substantially vertical side of the upper portion 13, as discussed in more detail later herein and shown specifically in FIG. 6.

Preferred embodiments of the actuator nozzle 10 have a substantially vertical central axis 30 that extends through the internal channel 20. The lower portion 12 of the actuator nozzle 10 may be substantially symmetrical around the substantially vertical central axis 30. For example, the internal channel 20 may be substantially symmetrical around the substantially vertical central axis 30 throughout the lower portion 12 of the actuator nozzle 10. The internal channel 20 may have a substantially constant diameter, with the substantially vertical central axis 30 at the center, throughout the entirety of the height of the lower portion 12.

Additionally or alternatively, the exterior surface of the lower portion 12 of the actuator nozzle 10 may be substantially symmetrical around the substantially vertical central axis 30. The exterior surface of the lower portion 12 of the actuator nozzle 10 may have a substantially constant diameter, with the substantially vertical central axis 30 at the center, throughout the entirety of the height of the lower portion 12.

The upper portion 13 of the actuator nozzle 10 may comprise a tapered section 13a and a substantially vertical section 13b. The one or more pressure points 15 may be positioned on the tapered section 13a, and the upper orifice 22 may be defined between the top of the tapered section 13a and the top of the substantially vertical section 13b. Preferably the tapered section 13a has a height greater than that of the substantially vertical section 13b, such that the upper orifice 22 is angled downward relative to the substantially vertical central axis 30, as shown specifically in FIG. 6. The top of the substantially vertical section 13b may curve upward to accommodate the oval or semi-circle shape of the upper orifice 22.

Preferably the tapered section 13a may taper inward on one side of the upper portion 13 of the actuator nozzle 10, as the upper portion 13 extends upward, while the substantially vertical section 13b on the opposite side of the upper portion 13 may maintain substantially vertical orientation as the lower portion 13 extends upward. In some embodiments, the internal channel 20 may have a continuously decreasing horizontal cross-section throughout the upper portion 13 of the actuator nozzle 10, as the upper portion 13 extends upward from the lower portion 12 to the upper orifice 22. Additionally or alternatively, the exterior surface of the upper portion 13 may have a continuously decreasing horizontal cross-section throughout the upper portion 13 of the actuator nozzle 10, as the upper portion 13 extends upward from the lower portion 12 to the upper orifice 22.

To use the actuator nozzle 10, an individual (such as a consumer) presses a finger (e.g., a single finger) on at least one of the one or more pressure points 15 to thereby open the valve. Then the fluid product from the container may enter the internal channel 20 of the actuator nozzle 10, then may travel through the internal channel 20 to the upper orifice 22, and then may be dispensed from the actuator nozzle 10 through the upper orifice 22. The actuator nozzle 10 may be positioned so that the upper orifice 22 faces the intended dispensation destination of the fluid product, for example the top of a beverage such as coffee or tea, to thereby direct the fluid product to the intended dispensation destination.

Any pressurized fluid product may be used in the actuator nozzle 10, and the present disclosure is not limited to a specific pressurized fluid product. Nevertheless, preferred embodiments of the pressurized fluid product include a foaming liquid creamer. Non-limiting examples of suitable components of the foaming liquid creamer include one or more of sugar, oil, buffer salt, stabilizing hydrocolloid, casein, emulsifier, flavor, water and any combination thereof. Any suitable propellant gas may be used in the aerosol can, such as any food grade inert gas, for example N₂, N₂O, HFC, HCFC or CO₂.

In some embodiments, the foaming liquid creamer is sterilized by ultra-high temperature (“UHT”) utilizing a temperature between 125° C. and 150° C. for a time between about 1 second and 5 minutes; then homogenized at a pressure from about 30 bar to 350 bar; then aseptically packaged into the aerosol cans with the addition of the propellant gas. Additionally or alternatively, the foaming liquid creamer is subjected to batch pasteurization, for example in a batch agitated tank. In a particular non-limiting embodiment, the foaming liquid creamer is subjected to batch pasteurization under conditions in which the creamer has a pH of about 7.5, a process temperature range is at least about 170.0° F., an air space temperature range is at least about 160.0° F., a hold time in the batch agitated tank is at least about 30.0 minutes, a temperature of the creamer at end of hold time in the tank is at least 170.0° F., and a product cooling temperature at the filler is about 50.0° F., with container cooling after closure.

In some embodiments, the actuator nozzle 10, which enables the fluid product to be injected, e.g., into coffee with formation of a smooth fine-pored foam, is mounted on the valve of the aerosol can. Preferably a foam is generated during use of the aerosol packaging comprising the actuator nozzle 10. The foam can be used in beverages such as coffee or hot chocolate, or in conjunction with another food, for example in a dessert, e.g., as a topping on puddings, pastries, fruits or fruit salads, or ice cream. The product may be present in the can in liquid form, but in spraying by means of the propellant gas, the actuator nozzle 10 may generate foam.

In some embodiments, the fluid product is a foaming liquid creamer comprising one or more of water, a sugar, an oil, a buffer salt, a stabilizing hydrocolloid, a protein, an emulsifier, or a flavor.

Non-limiting examples of suitable buffer salts include monophosphates, diphosphates, triphosphates, hexamethaphosphates, sodium mono- and bicarbonates, potassium mono- and bicarbonates, or a combination thereof. Preferred buffer salts are potassium phosphate, dipotassium phosphate (also known as potassium phosphate dibasic), potassium hydrophosphate, sodium bicarbonate, sodium citrate, sodium phosphate, disodium phosphate, sodium hydrophosphate, sodium tripolyphosphate and hexametaphosphates.

Non-limiting examples of suitable stabilizing hydrocolloids include carrageenan, such as kappa-carrageenan, iota-carrageenan, and/or lambda-carrageenan; starch, such as modified starch; cellulose, such as microcrystalline cellulose, methyl cellulose, or carboxy-methyl cellulose; agar; gelatin; gellan such as high acyl gellan and/or low acyl gellan; guar gum; gum Arabic; konjac; locust bean gum; pectin; sodium alginate; maltodextrin; tragacanth; xanthan; or a combination thereof.

Non-limiting examples of suitable proteins include milk protein, such as micellar casein, caseinate (e.g., sodium caseinate), and whey protein; a vegetable protein such as soy protein or pea protein; and any combination thereof.

Non-limiting examples of suitable emulsifiers include monoglycerides, diglycerides, acetylated monoglycerides, sorbitan trioleate, glycerol dioleate, sorbitan tristearate, propyleneglycol monostearate, glycerol monooleate and monostearate, sorbitan monooleate, propylene glycol monolaurate, sorbitan monostearate, sodium stearoyl lactylate, calcium stearoyl lactylate, glycerol sorbitan monopalmitate, diacetylated tartaric acid esters of monoglycerides, succinic acid esters of mono- and/or diglycerides, lactic acid esters of mono- and/or diglycerides, sucrose esters of fatty acids, lecithin (e.g. soy lecithin, canola lecithin, sunflower lecithin, and/or safflower lecithin), lysolecithins, and combinations thereof.

The following example of a foaming liquid creamer, which is suitable for use in aerosol packaging including the actuator nozzle 10 disclosed herein, is presented merely for illustration and does not limit the scope of the present disclosure. All percentages expressed herein are by weight of the total weight of the composition unless expressed otherwise.

| | | |
|---|---|---|
| Sugar | 22.5 | 18 |
| Oil | 7.5 | 5.5 |
| Buffer salts | 0.5 | 0.5 |
| Stabilizing Hydrocolloids | 0.3 | 0.3 |
| Casein | 0.7 | 0.6 |
| Emulsifiers | 0.3 | 0.3 |
| Flavor | 0.2 | 0.2 |
| Water | 68.0 | 74.6 |

### EXPERIMENTAL EXAMPLE

Comparative tests were performed between a star-tip nozzle, which is a common commercial actuator nozzle, and the inventive nozzle according to the present disclosure, each on an aerosol can pressurize by nitrous oxide and containing a foaming liquid creamer, and all parameters identical except the nozzle.

The comparative tests were conducted as follows:
1) Fill clear plastic cup with cold coffee containing ice.
2) Shake aerosol can for about three seconds.
3) Dispense foaming liquid creamer from the pressurized can, through the nozzle, into cup for four seconds, while moving the pressurized can in circular motion.
4) Record foaming integrity (foam height, bubble size density).

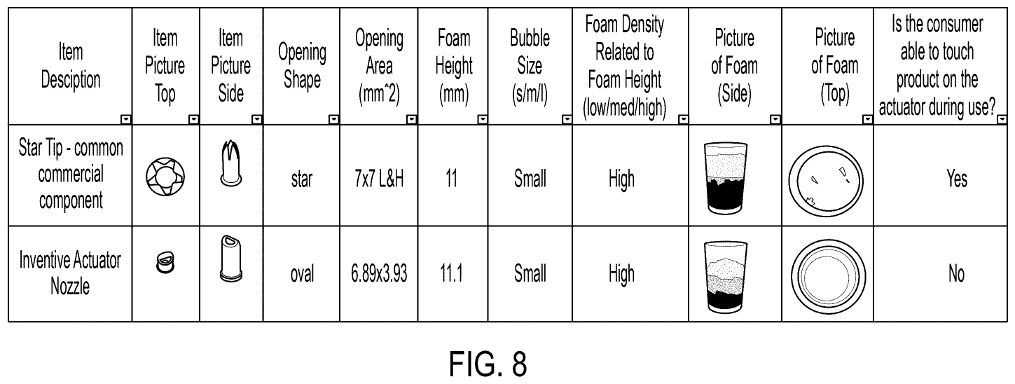

FIG. 8 shows the experimental results from these comparative tests. The results showed that the inventive actuator nozzle of the present disclosure was capable of achieving good foam quality, as shown by small bubble size (less than 0.2 mm) and high foam density (maintaining a height greater than 10 mm). The inventive nozzle also provided significantly less mess than the star-tip nozzle which is a common commercial actuator nozzle, because the consumer was able to touch the foaming liquid creamer on the star-tip nozzle during use, but was not able to touch the foaming liquid creamer during use of the inventive nozzle.

### CONCLUSION

It should be understood that various changes and modifications to the example embodiments described herein will be apparent to those skilled in the art. Such changes and modifications can be made without departing from the spirit and scope of the present subject matter and without diminishing its intended advantages. It is therefore intended that such changes and modifications be covered by the appended claims.

It should be appreciated that 35 U.S.C. 112(f) or pre-AIA 35 U.S.C 112, paragraph 6 is not intended to be invoked unless the terms “means” or “step” are explicitly recited in the claims. Accordingly, the claims are not meant to be limited to the corresponding structure, material, or actions described in the specification or equivalents thereof.

1. An actuator nozzle comprising:
a lower portion comprising a base configured to connect to a container, the base comprising a lower orifice;
an upper portion comprising a tapered section on one side of the upper portion, the tapered section tapers inward as the tapered section extends upward from the lower portion, the upper portion further comprising a substantially vertical section on an opposite side of the upper portion from the tapered section; and
an upper orifice in fluid communication with the lower orifice by an interior channel of the actuator nozzle, the upper orifice angled downward from a top of the tapered section of the upper portion to a top of the substantially vertical section of the upper portion.

2. The actuator nozzle of claim 1, wherein the upper orifice has a shape that is oval or semi-circle and has a maximum width at or adjacent to the top of the tapered section.

3. The actuator nozzle of claim 1, wherein the lower portion of the actuator nozzle is substantially symmetrical throughout an entirety of the height of the lower portion.

4. The actuator nozzle of claim 1, comprising one or more pressure points configured to actuate and/or permit actuation of a valve on which the actuator nozzle is mounted.

5. The actuator nozzle of claim 4, wherein the one or more pressure points are positioned on the tapered section of the upper portion.

6. The actuator nozzle of claim 4, wherein the one or more pressure points and the upper orifice face opposite directions.

7. The actuator nozzle of claim 1, which is partially or entirely made of plastic.

8. The actuator nozzle of claim 1, wherein the tapered section of the upper portion has a height greater than that of the substantially vertical section of the upper portion.

9. An aerosol packaging comprising a pressurized container and further comprising the actuator nozzle of claim 1.

10. The aerosol packaging of claim 9, wherein the pressurized container is a pressurized aerosol can containing a foaming liquid creamer.

11. The aerosol packaging of claim 9, comprising a valve on which the actuator nozzle is mounted and configured to reversibly open and close the internal channel of the actuator nozzle.

12. A method of manufacturing an aerosol packaging, the method comprising attaching the actuator nozzle of claim 1 to a pressurized container.

13. The method of claim 12, comprising filling a foaming liquid creamer into the container before the attaching of the actuator nozzle to the container.

14. The method of claim 12, wherein the attaching the actuator nozzle to the pressurized container comprises mounting the actuator nozzle on a valve that is part of or attached to the container.

15. A method of dispensing a fluid product from a container, the method comprising directing the fluid product from the container through the actuator nozzle of claim 1.

16. The method of claim 15, wherein the directing the fluid product through the actuator nozzle comprises forming a jet stream of the fluid product from the upper orifice and/or deflecting the fluid product between outer edges of the upper orifice to thereby create foam on top of beverage which the upper orifice is facing.

17. The method of claim 15, wherein the directing of the fluid product through the actuator nozzle forms a foam creamer on a beverage without use of tools or utensils.
